(19) United States
(12) Patent Application Publication
(10) Pub. No.: US 2025/0083154 A1
(43) Pub. Date: Mar. 13, 2025

(54) Separator Wheel with Hybrid Separator Wheel Vanes for Wear Protection Purposes

(71) Applicant: NETZSCH-Feinmahltechnik GmbH, Selb (DE)

(72) Inventor: Sergio Alegre, L’ Hospitalet de Llobregat, Barcelona (ES)

(21) Appl. No.: 18/826,263

(22) Filed: Sep. 6, 2024

(30) Foreign Application Priority Data
Sep. 11, 2023 (DE) 10 2023 124 410.8

(51) Int. Cl. B02C 13/28; B02C 13/18

(52) U.S. Cl. CPC B02C 13/2804; B02C 13/18; B02C 2013/2812; B02C 2210/02

(57) ABSTRACT

A separator wheel with hybrid separator wheel vanes, which each consist of at least one vane base body, the radially outward area of which is provided at least on the side, which leads during operation as intended with at least one plating strip made of a wear protection material, which differs from the material of the vane carrier, ideally a carbide material or a ceramic material, which is wherein the at least one plating strip has at least one, preferably several positive-locking elements, which each engages or engage with a corresponding positive-locking element of the vane base body.

The invention relates to a centrifugal separator or a separator mill, respectively, with an improved separator wheel and a separator wheel for such a separator.

### TECHNICAL FIELD

Separator mills operate wheels revolving at high speed, one of which is a separator wheel and the other is provided for grinding. Both wheels are arranged in the same chamber and achieve a comminution and a classification of the feed material. The separator wheel typically has a drum-like shape. Its jacket surface is formed by means of numerous separator wheel vanes, which are located closely next to each other and which are held between two separator wheel disks. Adjacent separator wheel vanes leave a respective passage gap referred to as “separator gap” between each other.

The classification usually takes place in that smaller particles, which create only smaller centrifugal forces during circular movement, are introduced into the interior of the separator wheel by the carrier gas. These smaller particles then form a fine material fraction, which is discharged together with the carrier gas via an end face of the separator wheel.

This does not work with larger particles. In the case of a pure separator, the coarse particles are discharged via the coarse material outlet, as otherwise usable fraction or for the purpose of a regrinding. In the case of a separator mill, the coarse particles bump against the operating area of the grinding wheel—often even repeatedly—and are crushed thereby. The smaller particles newly created in this way are introduced into the interior of the separator wheel by the carrier gas stream. The larger particles remaining even after the described collision experience further collisions in rapid succession. They are comminuted and separated even further thereby. They are also further accelerated in the circumferential direction thereby, however.

This also leads to the impact of the particles, which are still being ground, onto the separator wheel vanes.

It is readily clear that the separator wheel vanes, which serve the purpose of crushing here, are exposed to a high impact wear in particular on their radially outward area, which leads in the direction of rotation.

In order to get a handle on the wear, it is already known to manufacture the separator wheel vanes of particularly wear-resistant material, for instance of a ceramic or a carbide material. These materials are more sensitive to notch impact, however. In the case of massive separator wheel vanes made of hard substances, a separator wheel vane can thus occasionally break. This occurs in particular when a particularly large particle impacts on the separator wheel vane, without breaking down immediately thereby. Due to the high operating speed, a vane break usually leads to significant secondary damages.

Due to this, it has also already been considered to use hybrid separator wheel vanes.

In the case of such separator wheel vanes, the separator wheel vane base body is still made of steel. For wear protection, a plating strip made of ceramic or carbide material is glued to its most highly stressed area. This has the advantage that virtually no or only the smallest fragments of the plating strip are released in the separator even in the event that such a plating strip breaks, whereby secondary damages can be largely avoided.

However, problems arise again and again. If particularly high-strength adhesives are used for adhering the plating strips, the regular replacement of the plating strips becomes very time-consuming. If an adhesive is used, which establishes a less solid bond, the risk of an unexpected release of the plating strip increases. This is then associated with destructions known from the breakage of a massive vane.

### SUMMARY

In light of this, it is the object of the invention to provide a separator wheel with a plating, which can be replaced more easily but which is nonetheless highly reliable, for a separator mill or a separator, which is largely only classified but which is nonetheless exposed to abrasive wear.

A separator wheel with hybrid separator wheel vanes is proposed according to the invention. Each separator wheel vane comprises a vane base body. The latter can be made of one piece or several pieces. The vane base body is already preferably made of a steel with abrasion resistance, which is increased compared to construction steel. The radially outward area of each vane base body carries—at least on its side, which leads during operation as intended—at least one plating strip made of a wear protection material, which differs from the material of the vane carrier. Ideally, a carbide material or a ceramic material is used for the plating. The separator wheel vane according to the invention is characterized in that the at least one plating strip has at least one, preferably several positive-locking elements, which are formed with it—preferably integrally in one piece. The positive-locking element or elements in each case engage with a corresponding positive-locking element of the vane base body. In other words, the positive-locking element, on the side of the plating strip, consists of the same, particularly wear-resistant material, of which the plating strip consists as well. The positive-locking elements as such also become more resistant against wear thereby because the complementary positive-locking element in the vane base body also profits directly.

Even though the bonding can be forgone only as an exception in this way, it is strengthened significantly.

The positive-locking element or elements are preferably selected so that they are able to hold the plating strip on the vane carrier during the ongoing operation even if the bonding fails. They are preferably designed so that they keep a portion of the stresses away from the bonding in the radially outward direction even during normal operation. A less solid adhesive can be used in this way, which allows being able to separate the respective plating strip from the vane base body again more quickly or more easily, respectively, in order to replace it. The reliability of the bonding is increased nonetheless, its failure becomes no longer probable.

Ideally, the bonding is not purely optional—the plating strip is thus then additionally glued to the vane base body. This creates an effect, which can be described with the key words laminated glass effect: if the plating strip is impacted strongly by a larger particle, it potentially shatters. All larger fragments remain in place, however, instead of being hurled back and forth in the separator and causing subsequent damages.

In the ideal case, the adhesive, which connects the plating strip to the vane base body, has a heat resistance, which is set in such a way that the connection between the vane base body and the plating strip can be broken by heating the hybrid separator wheel vane to a temperature, which does not yet entail a significant influence of the microstructure of the vane base body.

The heating in the range of at least 220° C. and of less than 280° C. is preferred.

The gluing can be released highly efficiently in this way in the course of changing the plating strips.

The positive-locking elements preferably interact with each other in such a way that the centrifugal forces acting on the plating strip during operation are mostly absorbed, preferably essentially and ideally completely by the positive-locking elements.

The gluing is relieved significantly thereby, bonds of low quality are sufficient.

Ideally, the vane base body has a recess, into which the plating strip can be placed in a flush manner namely preferably so that it forms an all-around, at least essentially, smooth-surfaced separator wheel vane together with the vane base body. There is thus no special starting point for the fact that powder gets stuck anywhere, which then possibly generates imbalances in the case of significant accumulation.

The recess, into which the plating strip is placed in a flush manner, is preferably formed essentially on the large surface of the vane base body, which leads during operation. The recess preferably extends over at least the radially outermost 25% of said large surface of the vane base body. The radially leading portion of that of the two large surfaces, which experiences most of the particle collisions, is protected well in this way.

It is particularly favorable when the at least one positive-locking element of the plating strip is formed in the area of the end thereof, which lies closest to the operating axis of rotation. The positive-locking element can be formed to be large and resistant in this area and a notch effect possibly emanating from it does not radiate or does not radiate significantly into the highly stressed area, in which a break caused by the impact of excessively large particles can possibly even occur. The positive-locking element additionally lies outside of the area, which is most strongly affected by wear.

It is favorable for the same reason when the positive-locking element is a protrusion, which protrudes—preferably radially—from the narrow surface of the plating strip, which lies closest to the operating axis of rotation.

It is favorable when the plating strip has a smaller thickness in the circumferential direction than the section of the vane base body, to which it is glued.

Independently of what has been said, protection is also claimed for the use of a plating strip with at least one positive-locking element for the—ideally smooth-surfaced—plating of a separator vane of a separator wheel according to one of the preceding claims by suspending the plating strip in a vane base body.

Protection is also claimed for a separator mill for the impact grinding and classification of preferably soft to medium-hard substances, ideally up to 3.5 Mohs, ideally within a single housing, in which mill and separator are integrated, with at least one separator wheel according to one of the claims, which has already been established.

Further modes of action, advantages and design options of the invention follow from the below-described exemplary embodiment, which illustrates the invention.

### BRIEF DESCRIPTION OF DRAWINGS

FIG. 1 shows a turbo separator in section, in which the separator wheel according to the invention can likewise be used, for instance for separating particularly abrasive materials.

FIG. 2 shows a cutout of a separator wheel according to the invention.

FIG. 3 shows a detail view of a separator wheel according to the invention.

FIG. 4 shows a separator wheel vane with a vane base body, which carries a plating strip.

### DETAILED DESCRIPTION

In the case of a turbo separator, which primarily serves the purpose of separating—which will be identified below as exemplary embodiment—the situation is similar as in the case of the above-cited separator mills. This is so because these devices are comparable with regard to their general operating principle. Unless specified otherwise, what will be described below thus also applies for the grinding separators, which are likewise claimed.

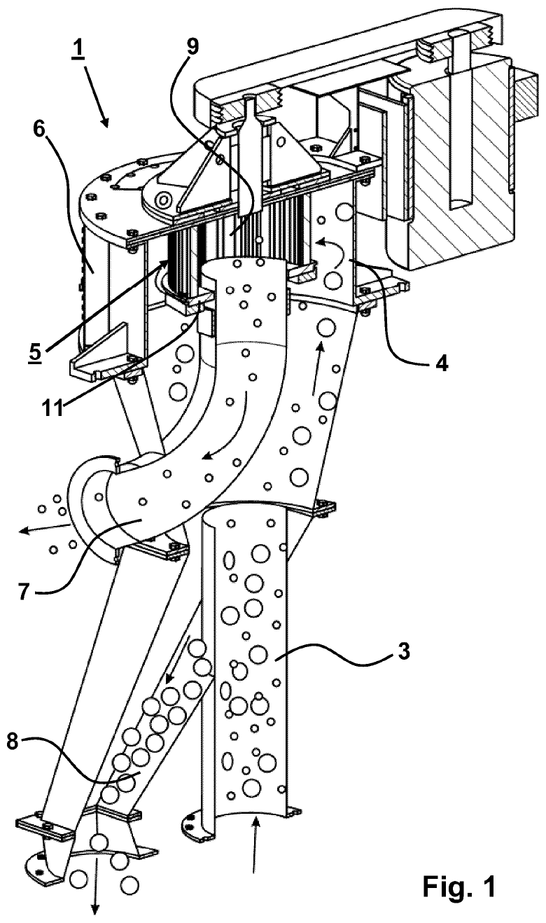

FIG. 1 shows a vertical separator with separator wheel according to the invention.

The mixture of coarse and fine material is brought close from the bottom via the feed pipe 3 with the help of a carrier air stream. The feed pipe 3 ends centrally in the separator drum 6. It keeps its distance from the inner circumferential jacket surface of the separator drum 6, along which the coarse material fraction is discharged.

From there, it reaches into the separator chamber 4, which is formed between the outer circumference of the separator wheel 5 and the separator drum 6 encasing it.

With its separator wheel vanes 9, which are spaced apart from each other, the separator wheel 5 can already be seen quite well in FIG. 1.

The fine material entrained by the carrier air stream can pass the separator gaps between adjacent separator wheel vanes 9. It enters into the interior of the separator wheel 5 in this way and is then discharged by the carrier stream via a perforated end face of the separator wheel 5, into the pipe 7 forming the discharge for the fine material fraction. The coarse material does not manage to enter into the interior of the separator wheel 5, past the separator wheel vanes 9. Instead, it is accelerated by the separator wheel 5 in the circumferential direction. It then falls out—mostly in a downward sloping spiral line—along the inner circumferential jacket surface of the separator drum, into the pipe 8, which forms the outlet for the coarse material fraction.

In particular when separating harder or abrasive material, the separator wheel vanes are likewise at risk of wearing in the area of their radially outward front edge, which leads in the direction of movement—even if the wear intensity may be pronounced less than in the case of a separator mill.

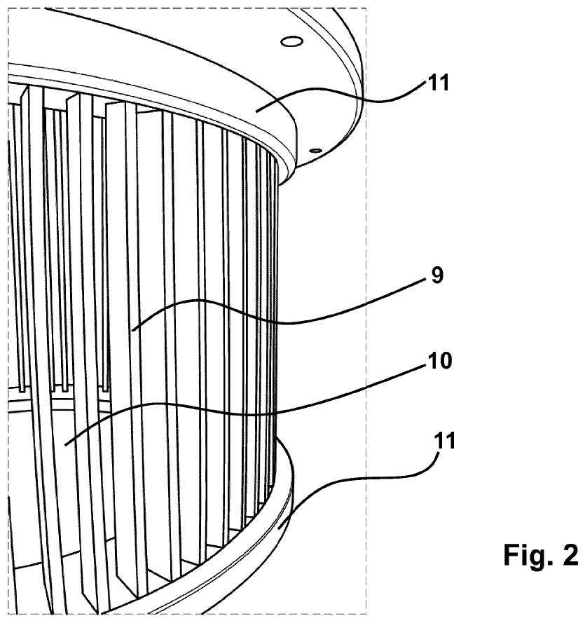

FIG. 2 shows a cutout of the separator wheel 5, which can in fact already be seen well in FIG. 1. As can be seen, the separator wheel 5 has a drum-shaped shape. Its jacket surface is formed by means of numerous separator wheel vanes 9, which are located closely next to each other. As can be seen more clearly in FIG. 2, adjacent separator wheel vanes 9 leave a respective passage gap 10 between each other. The separator wheel vanes 9, which are located closely next to each other, are held between two separator wheel disks 11, which are each arranged on the end face of the separator wheel, usually in a positive-locking manner.

As can be seen, the separator wheel vanes 9 have large surfaces 12. They each delimit said separator gap, through which the carrier air stream can flow into the separator wheel with the fine material fraction. All the way on the outer circumference, the separator wheel vanes have a radially outward narrow surface 13.

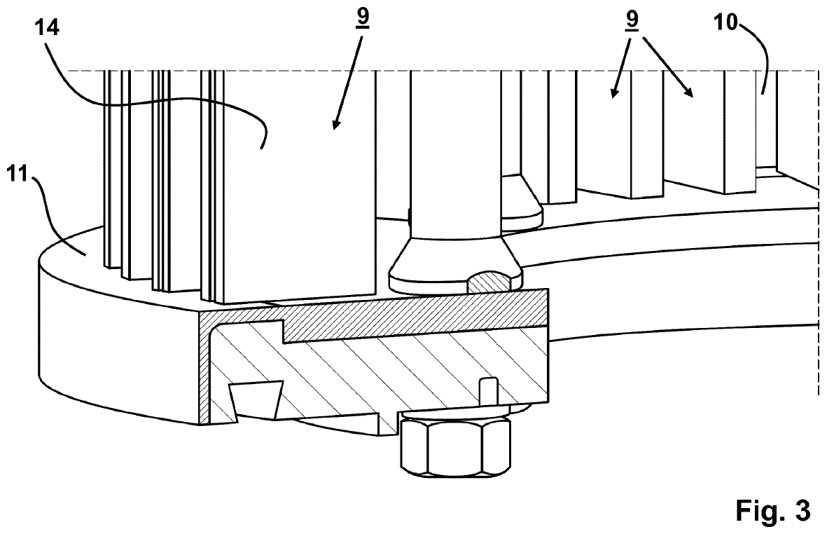

As can be seen best on the basis of FIG. 3, the separator wheel disks 11 are in many cases also provided with a plating, typically with a carbide coating or with a ceramic covering.

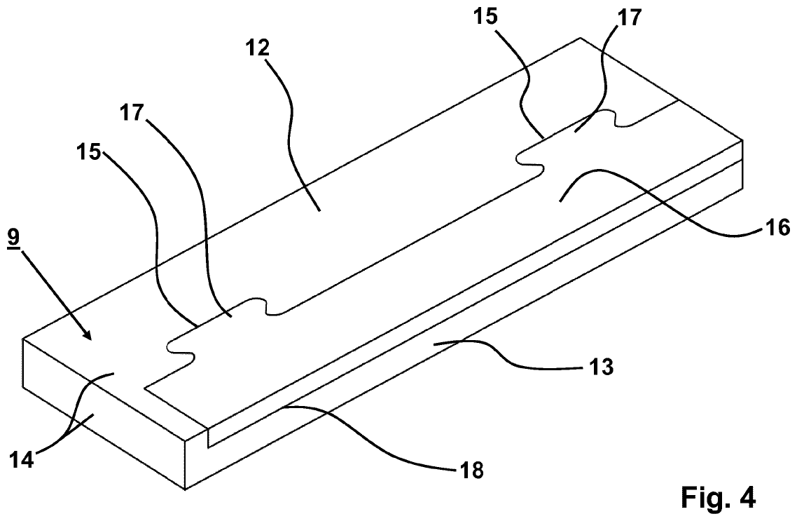

FIG. 4 shows an exemplary embodiment for one of the separator wheel vanes 9 according to the invention.

It can be seen well that the separator wheel vane 9 comprises a vane base body 14. This vane base body 14 usually consists of steel. It has proven to be ideal, if this steel is also already a hardened steel or a steel, which is provided with an increased wear resistance in any other way.

It can be seen well that the vane base body 14—essentially on its large surface, which leads during operation—has a recess 15, which is formed in a stair-like manner. It provides a free space for the preferably smooth-surfaced insertion of a plating strip 16. The plating strip is preferably embodied in one piece. The vane base body usually completely supports the plating strip on its rear side, which lies opposite its free large surface. Preferably, the vane base body additionally also supports the plating strip on one, or preferably even on three of its narrow end and side faces.

Said smooth-surfaced insertion optionally means that the plating strip fits in so that it does not form an edge or protrusion anywhere, which protrudes over the vane base body and on which material to be separated could accumulate.

The radially outward end face of the separator wheel vane can also be seen well here.

As can be seen, the plating strip, according to the invention, carries at least one and here preferably several positive-locking elements 17. The positive-locking elements 17 protrude in the area of the end of the plating strip lying closest to the operating axis of rotation. They have a shape, like the one, which is known from the positive-locking element of a puzzle piece. This means that the respective positive-locking element is a flat structure. This flat structure is connected via a “neck”, which is narrower than the rest of the flat structure, to the actual plating strip. The narrow edge surfaces of the flat structure are those, which establish the positive connection to the vane base body, which is significant in terms of the invention.

As can be seen here, the respective positive-locking element 17 is rounded continuously, thus free from essentially angular edges. The notch effect, which weakens the positive-locking element, is kept low in this way, which is important in particular in the case of a plating strip made of ceramic material. The positive-locking elements used here are thus superior to other positive-locking elements—for instance compared to pins, which are each inserted into the vane base body through a bore in the plating strip, in order to thus ensure a positive-locking anchoring.

As already mentioned, a complementary recess 18 on the vane base body 14 is assigned to the positive-locking element 17.

The positive-locking element 17 and the recess 18 interact in such a way that it is impossible that the plating strip is hurled radially outward even when the bond, which additionally holds it, fails.

Ideally, a distribution of work results with regard to raising the holding forces required for the plating strip: a more than only insignificant portion, mostly even a predominant portion of the centrifugal forces acting in the radially outward direction is absorbed by the positive-locking elements. The bond is at least primarily, mostly even virtually solely, responsible for the fact that the plating strip cannot be released from its positive-locking radial anchoring.

It is also noteworthy that it is particularly favorable when the recess 15 does not reach all the way to the short end face of the vane base body 14, as shown in FIG. 2 on the left-hand side. This is so because the vane base body 14 then makes it possible to replace the plating strip even if the vane base body is still held by the separator wheel disks on its short end-face edge.

1. A separator wheel comprising hybrid separator wheel vanes, which each include at least one vane base body, the radially outward area of which is provided at least on the side, which leads during operation as intended with at least one plating strip made of a wear protection material, which differs from the material of the vane carrier, ideally a carbide material or a ceramic material, wherein the at least one plating strip has at least one, preferably several positive-locking elements, which each engages or engage with a corresponding positive-locking element of the vane base body.

2. The separator wheel according to claim 1, wherein the plating strip is additionally glued to the vane base body.

3. The separator wheel according to claim 2, wherein the adhesive, which connects the plating strip to the vane base body, has a heat resistance, which is set in such a way that the connection between the vane base body and the plating strip can be broken by heating the hybrid separator wheel vane to a temperature, which does not yet entail a significant influence of the microstructure of the vane base body.

4. The separator wheel according to claim 1, wherein the positive-locking elements interact with each other in such a way that the centrifugal forces acting on the plating strip during operation are absorbed by the positive-locking elements.

5. The separator wheel according to claim 1, wherein the vane base body has a recess, into which the plating strip can be placed in a flush manner.

6. The separator wheel according to claim 5, wherein the recess is formed essentially on the large surface of the vane base body, which leads during operation and preferably extends over at least the radially outermost 25% of said large surface of the vane base body.

7. The separator wheel according to claim 5, wherein the at least one positive-locking element of the plating strip is formed in the area of the end thereof, which lies closest to the operating axis of rotation.

8. The separator wheel according to claim 7, wherein the positive-locking element is a protrusion, which protrudes—preferably radially—from the narrow surface of the plating strip, which lies closest to the operating axis of rotation.

9. The separator wheel according to claim 1, wherein the plating strip has a smaller thickness in the circumferential direction than the section of the vane base body, to which it is glued.

10. The separator wheel of claim 1 having a plating strip with at least one positive-locking element for—ideally large-surface—plating of a separator wheel vane by suspending the plating strip in a vane base body.

11. A separator mill for the impact grinding and classification of preferably soft to medium-hard substances, ideally up to 3.5 Mohs, with at least one separator wheel comprising hybrid separator wheel vanes, which each include at least one vane base body, the radially outward area of which is provided at least on the side, which leads during operation as intended with at least one plating strip made of a wear protection material, which differs from the material of the vane carrier, ideally a carbide material or a ceramic material, wherein the at least one plating strip has at least one, preferably several positive-locking elements, which each engages or engage with a corresponding positive-locking element of the vane base body.

12. The separator wheel according to claim 2, wherein the positive-locking elements interact with each other in such a way that the centrifugal forces acting on the plating strip during operation are absorbed by the positive-locking elements.

13. The separator wheel according to claim 2, wherein the vane base body has a recess, into which the plating strip can be placed in a flush manner.

14. The separator wheel according to claim 2, wherein the recess is formed essentially on the large surface of the vane base body, which leads during operation and preferably extends over at least the radially outermost 25% of said large surface of the vane base body.

15. The separator wheel according to claim 2, wherein the at least one positive-locking element of the plating strip is formed in the area of the end thereof, which lies closest to the operating axis of rotation.

16. The separator wheel according to claim 2, wherein the positive-locking element is a protrusion, which protrudes—preferably radially—from the narrow surface of the plating strip, which lies closest to the operating axis of rotation.

17. The separator wheel according to claim 2, wherein the plating strip has a smaller thickness in the circumferential direction than the section of the vane base body, to which it is glued.
